(19) United States
(12) Patent Application Publication
(10) Pub. No.: US 2017/0217126 A1
(43) Pub. Date: Aug. 3, 2017

(54) FOAM STRUCTURE AND PROTECTIVE PAD HAVING SAME

(71) Applicant: Chang Hsin WU, Xingang Township (TW)

(72) Inventor: Chang Hsin WU, Xingang Township (TW)

(21) Appl. No.: 15/415,897

(22) Filed: Jan. 26, 2017

(30) Foreign Application Priority Data
Jan. 30, 2016 (TW) 105201541

(51) Int. Cl. B32B 5/18; B32B 5/02; B32B 3/26

(52) U.S. Cl. CPC B32B 5/18; B32B 3/266; B32B 5/02; B32B 2307/50

(57) ABSTRACT

A foam structure is provided. The foam structure includes a plurality of resilient elements and a plurality of flexible connecting elements connected between the resilient elements. The resilient element comprises an upper material layer, a lower foam material layer, and an intermediate material layer. Two adjoining intermediate material layer are connected with each other through at least one connecting element provided therebetween, but an interspace is also provided therebetween. The resilient elements and flexible connecting elements may be integrally formed by integral molding with a foam material as a one-piece foam structure.

### FIELD OF THE INVENTION

The present invention relates generally to protective body wear and, more particularly, to a foam structure as a protective pad for cushioning.

### BACKGROUND OF THE INVENTION

Typically, it is known to provide protective equipment for players in sports activities, especially where the sport involved high impact or the risk of injury from projectiles or bodily contact.

Prior art protective equipment commonly employs a anti-collision protective pad that is strapped to the body, e.g., soccer shin guards, helmets, and the like, or a soft, padded covering that is worn as a garment over clothing, e.g., baseball catcher's padded vests, knee and elbow pads for volleyball and basketball, and the like. However, the anti-collision protective pad of the protective equipment of prior art is made of a whole foamed pad so that a fitting property is poor. Namely, the anti-collision protective pad made of the whole foamed pad cannot fully attached onto a surface of a portion of a user' skin. The problem of insufficient attachment cannot be solved. Attempts have been made to make the foregoing materials appear less stiff to the wearer by creating thinner regions in each piece which allows better flexing. But foamed pads manufactured this way cannot offer full range of motion at the location of the padding, because the material breaks apart when flexed at the thinner areas.

Moreover, a surface of the foamed pad is smooth. The surface of the foamed pad contacting with the skin does not does not provide adequate surface ventilation and permeability. Furthermore, the surface of the foamed pad is too smooth to provide adequate friction between the skin and the surface of the foamed pad.

Thus, it is necessary to provide foam structure to solve the problems of the prior art.

### SUMMARY OF THE INVENTION

For the reasons mentioned above, the invention provides a foam structure for improving in-wear comfort and permeability of the anti-collision protective gear of the protective equipment.

According to one embodiment of the present invention, a foam structure is provided which comprises a plurality of resilient elements for deforming to absorb energy when an external force is applied thereon; and a plurality of flexible connecting elements, each for connecting between at least two of the resilient elements; wherein at least a portion of the resilient elements are provided with a concave portion on a top surface thereof, and wherein among a plurality of adjacent pairs of the resilient elements, at least a portion of the plurality of adjacent pairs are each provided with an interspace therebetween.

According to another embodiment of the present invention, the plurality of resilient elements each comprises a first material layer made of resilient foam material, and a second material layer provided above first material layer, and the flexible connecting elements are connected between the second material layers.

According to another embodiment of the present invention, the plurality of resilient elements each comprises further comprises a third material layer above the second material layer.

According to another embodiment of the present invention, the foam structure is provided with a top fabric over a top surface of the first material layer and a bottom fabric over a bottom surface of the first material layer, and wherein the top fabric and the bottom fabric are an air permeable fabric.

According to another embodiment of the present invention, The foam structure as defined in claim 3, wherein the concave portion on the top surface of the resilient elements is formed by a through hole on the third material layer, a through hole of the second material layer, and a dimple on the first material layer.

According to another embodiment of the present invention, the resilient elements are resilient columnar elements, and a shape of a transection of the resilient columnar element is of one of the following shapes: triangle, square, rectangle, hexagon, circle, oval, and polygon.

According to another embodiment of the present invention, a shape of the resilient element is of one of the following shapes: hexagonal column, cylinder, triangular prism, quadrangle prism, spheroid, ellipsoid, and cone.

According to another embodiment of the present invention, the plurality of resilient elements and the plurality of flexible connecting elements are integrally formed by integral molding of foam material.

These and other aspects of the invention will become apparent to those skilled in the art after a reading of the following description of the embodiments when considered with the drawings.

### DESCRIPTION OF THE DRAWINGS

In order to more clearly describe the embodiments of the present invention, the accompanying drawings for illustrating the embodiments are briefly described below. The following description of the drawings are merely about some embodiments of the present invention, those of ordinary skill in the art can also obtain other drawings based on these drawings without creative effort.

FIG. 1 is a schematic view of a foam structure according to a first embodiment of the invention;

FIG. 2 is an exploded view of the foam structure according to the first embodiment of the invention;

FIG. 3 is a cross-sectional view of the foam structure in FIG. 1;

FIG. 4 is an exploded view of the foam structure according to a second embodiment of the invention;

FIG. 5 is cross-sectional view of the foam structure in FIG. 4; and

FIG. 6 is a schematic view of a foam structure according to a third embodiment of the invention.

### DETAILED DESCRIPTION OF THE PREFERRED EMBODIMENTS

Referring to the drawings of the embodiments of the invention, the same component is labeled as the same number. The following description is based on the particular illustrated embodiments of the invention, which should not be construed as limiting the invention.

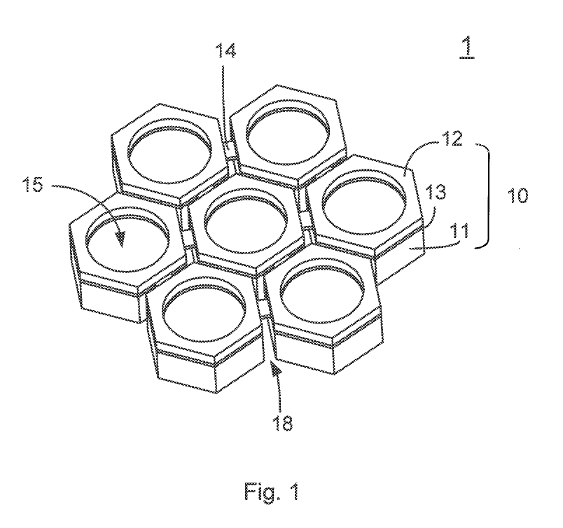

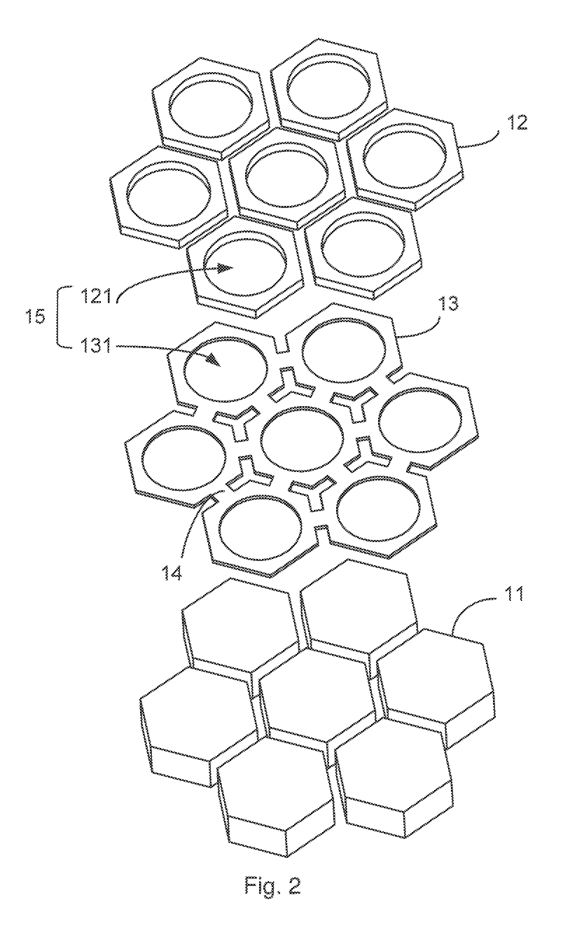

Please refer to FIGS. 1-2, which are the schematic view and exploded view of a foam structure according to a first embodiment of the invention. The first embodiment of the invention provides an foam structure 1 for a protective pad (not shown) for fixing in/on a sportswear (not shown), which comprises a plurality of resilient elements 10 spaced apart from each other by an interspace 18. According to an embodiment of the shape of the resilient element 10, it may take the shape of a column such that the resilient element 10 is a resilient columnar element 10. The columnar element 10 comprises a lower foam sheet 11, a upper foamed sheet 12, and an intermediate piece 13.

According to an embodiment of the invention, the columnar element 10 can be a hexagonal cylinder, but is not limited thereto.

A surface of the lower foam sheet 11 can be attached on a user's skin or attached on the sportswear, such as sport pants, sweat clothes, shoulder pads, rib protectors, hip pads. A surface of the upper foamed sheet 12 is disposed outwardly for contacting with other objects.

The foam structure 1 may comprise a plurality of columnar elements 10 foam structure to form the protective pad. Two adjacent columnar elements 10 are separated by the interspace 18. Thus, there is a space between the columnar elements 10. The interspace 18 between the columnar elements 10 is utilized for increasing air permeability since the moisture can be released through the interspace 18.

The upper foamed sheet 12 is disposed above the lower foam sheet 11. The intermediate piece 13 is disposed between the upper foamed sheet 12 and the lower foam sheet 11. In other words, the lower foam sheet 11 is adhered to one surface of the intermediate piece 13. The lower foam sheet 11 is disposed below the intermediate piece 13. Additionally, the upper foamed sheet 12 is adhered to the other surface of the intermediate piece 13. The upper foamed sheet 12 is disposed above the intermediate piece 13.

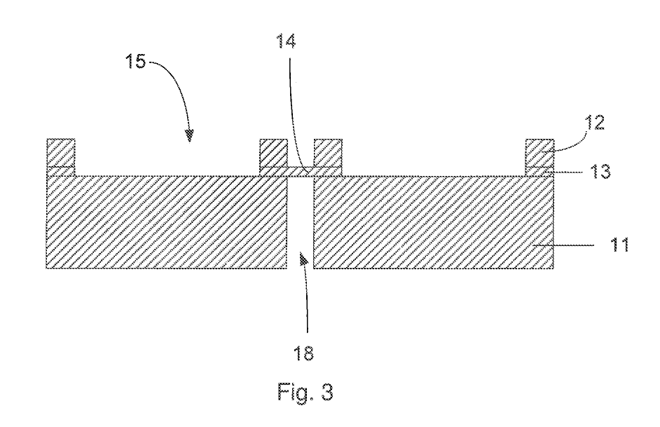

According to an embodiment of the invention, the intermediate piece 13 includes at least one connecting segment 14, each for connecting one intermediate piece 13 to another intermediate piece 13. Namely, two adjoining intermediate pieces 13 are connected with each other through at least one connecting segment 14 provided therebetween. Each of the intermediate pieces 13 connected to different columnar elements 10 is connected with other intermediate piece(s) 13 through the connecting segment 14, as shown in FIG. 3. Therefore, the connecting segment 14 enhances the overall structural stability of the foam structure 1 so as to avoid the columnar elements 10 being peeled from the sportswear.

According to an embodiment of the invention, the intermediate piece 13 and the connecting segment 14 are formed integrally. Two adjacent columnar elements 10 are connected with each other through the connecting segment 14 so that the two adjacent columnar elements 10 jointly withstand the external forces and/or the potential vibration exerted thereon.

In this embodiment of the invention, the upper foamed sheet 12 comprises a first through hole 121, as shown in FIG. 2. The intermediate piece 13 comprises a second through hole 131 corresponding to the first through hole 121, as shown in FIG. 2. The first through hole 121 and the second through hole 131 are configured to form a concave portion 15 on the top surface of the columnar element 10 for increasing a contact friction between the foam structure and a contact surface. In the present embodiment, although the resilient columnar elements 10 takes the shape of a column, in another embodiment of the invention, the shape of the resilient elements 10 can be other than a column, but take the shape of the following: spheroid, ellipsoid, cone, or other forms.

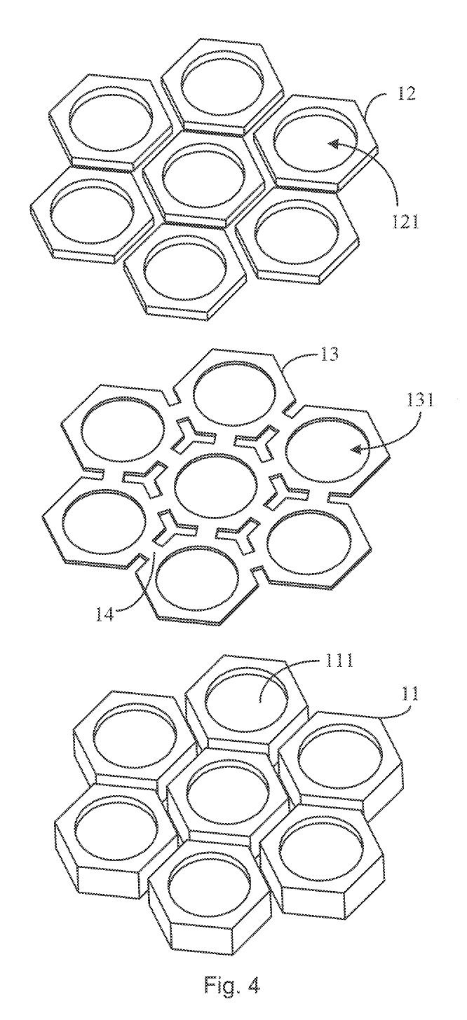

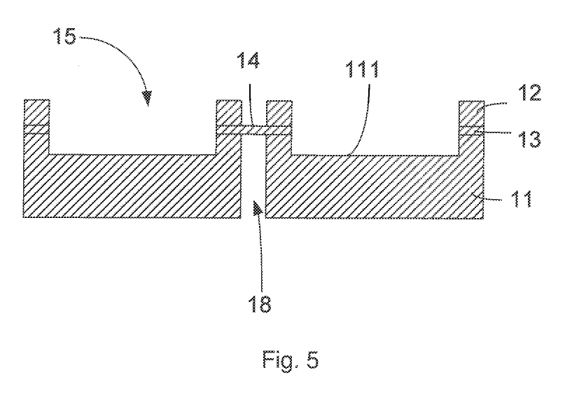

Please refer to FIGS. 4-5, which are the schematic view and exploded view of a foam structure according to a second embodiment of the invention. The difference between the second embodiment and the first embodiment is that the lower foam sheet 11 comprises a dimple 111 provided on its upper surface and corresponding to the second through hole 131 and the first through hole 121. The design of the through holes 121, 131 and the dimple 111 forms a concave portion 15 on the top surface of the columnar element 10 so as to increase the contact friction of the foam structure with other objects.

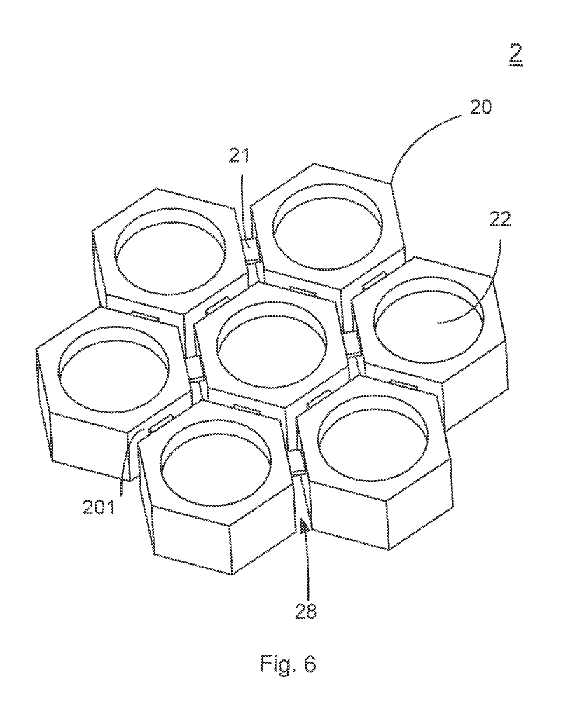

Please refer to FIG. 6, which is a schematic view of a foam structure according to a third embodiment of the invention. The difference between the third preferred embodiment and the first or second embodiment is that the lower foam sheet 11, the upper foamed sheet 12 and the intermediate piece 13, together with the connecting segment 14 as described above are formed integrally by integral molding as a one-piece resilient foam unit 20. In more detail, the molded foam structure 2 comprises a plurality of resilient foam unit 20 spaced apart from each other by an interspace 28 but connected together by a plurality of connecting segments 21. Additionally, a shape of the resilient foam unit 20 is selected from the group consisting of cylinder, hexagonal column, triangular prism, quadrangle prism, spheroid, ellipsoid, cone, and cube, but not limited thereto. The connecting segment 21 is formed between two resilient foam unit 20 on a surface of a sidewall 201 of the resilient foam unit 20. That makes a process of manufacturing the resilient foam unit more streamlined than the conventional manufacturing process.

According to an embodiment of the invention, the resilient foam unit 20 comprises a dimple 22 formed on a top surface thereof. The design of the dimple 22 can increase the contact friction of the foam structure with other object.

In other embodiment of the invention, the foamed unit 10, 20 is provided with an upper air permeable fabric and a lower air permeable fabric to for a protective pad.

According to an embodiment of the invention, the present foam structure, can be act as such as cushioning pads, anti-collision protective pad, and the like, can be incorporated into clothing, and can be designed to have specific functional characteristics. Such clothing is unique in its ability to provide mobile protection to areas of the body that flex, particularly joints. The foam structure can be incorporated into garments in a unique way, such that garment materials fit snugly, but stretch and conform to the body, or to a specific joint shape, resulting in an integrated padding system that protects the user from impact better than other products, because the pad is in constant and direct contact with the user during the full range of motion. Sportswears incorporating the present foam structure provide improved protection from injury when worn, because the columnar structure of the foam structure provides sufficient attachment and flexibility in direct contact with the user's body during use. The flexibility of the columnar design manner allows the foam structure to conform to a user's body shape, so that the foam structure can be maintained in contact with the user's body. Furthermore, the space between the columnar structures provides sufficient air permeability. Additionally, the connection between the columnar structures, such as the connecting segment of the invention can make the columnar structures to jointly withstand the impact force or shocks.

As described above, according to an embodiment of the invention, the foam structure of the invention provides a multi-layered foam structure comprising a bottom layer, a top layer and an intermediate piece disposed between the bottom layer and the top layer. The bottom layer and the top layer are distributed with interspace therein, respectively. The intermediate piece comprises at least one connecting segment for connecting with at least one adjoining intermediate pieces. A wearing device made of the foam structure of the invention provides a better fitting property than the anti-collision protective gear of the protective equipment of the prior art since the foam structure is set independently. The problem of insufficient attachment can be solved. In addition, the foam structure of the invention provides a better permeability than the anti-collision protective gear of the prior art since the interspace distributed therein. Moreover, the connecting segments can connect different intermediate pieces for the intermediate pieces jointly withstanding the shock. Thus, when compared to conventional foamed pads, the foam structure of the invention provides a superior fitting property and permeability than the conventional foamed pads.

According to one more embodiment of the present invention, a foam structure 1, 2 and a protective pad having the same are provided.

According to an embodiment of the invention, the foam structure 1, 2 comprises a plurality of resilient elements 10, 20 and a plurality of flexible connecting elements 14, 21 connected therebetween. According to an embodiment of the invention, one resilient element 10, 20 will be adjacent to some other resilient element(s), and the flexible connecting elements 14, 21 may be provided between either a portion of or all of the adjacent pairs of the resilient elements 10, 20.

According to an embodiment of the invention, among the adjacent pairs of the resilient elements 10, 20, a portion of or all of the adjacent pairs are provided with an interspace 18, 28 between the adjacent pair of the resilient elements 10, 20. According to an embodiment of the invention, the adjacent pair of resilient elements 10, 20 that are connected by the connecting elements are spaced apart with an interspace 18, 28 that allows air flow to pass through the foam structure so as to achieve the ventilation effect.

According to an embodiment of the invention, the resilient elements 10, 20 will deform to absorb so as to achieve the cushioning effect. According to an embodiment of the invention, the connecting elements 14, 21 connect the resilient elements 10, 20 together so that when one or more of the resilient elements 10, 20 receive an external force, the relative locations of the resilient elements 10, 20 are maintained to some extent by the connecting elements 14, 21. According to an embodiment of the invention, the connecting elements may 14, 21 share the external forces exerted on one the resilient element to other connected resilient elements 10, 20.

According to an embodiment of the invention, the resilient element 10 comprises a first material layer 11 made of resilient foam material, a second material layer 13 provided above the first material layer 11, and a third material layer 12 provided above the second material layer 13, where the upper surface of the first material layer 11 and the lower surface of the second material layer 13 are bonded together, and the upper surface of the second material layer 13 and the lower surface of the third material layer 12 are bonded together. In this embodiment, the first material layer 11 is a lower foam material layer 11, the second material layer 13 is an intermediate material layer 13, and the third material layer 12 is an upper material layer 12.

According to an embodiment of the invention, the three material layers are bonded by an adhesive. According to an embodiment of the invention, there can be the first material layer 11 and the second material layer 13 provided in the foam structure 10, but the third material layer 12 is not provided in the foam structure 10.

According to an embodiment of the invention, the connecting elements 14 are connected between the intermediate material layers 13 so that the resilient elements 14 are connected together. According to an embodiment of the invention, the flexible connecting element 14 is a flexible connecting segment 14. According to an embodiment of the invention, the flexible connecting element 14 is a sheet of flexible connecting segment 14.

According to an embodiment of the invention, lower foam material layer 11 is formed with one or more foam materials. According to an embodiment of the invention, both or either of the upper material layer 12 and the intermediate material layer 13 is formed with one or more foam materials. According to an embodiment of the invention, the intermediate material layer 13 is formed with a resilient material other than a foam material.

According to an embodiment of the invention, the intermediate material layers 13 and the connecting elements 14 are integrally formed by integral molding with one or more foam materials. According to an embodiment of the invention, the resilient elements 20 and the connecting elements 21 are integrally formed foam structure by integral molding with one or more foam materials. According to an embodiment of the invention, the one or more foam materials are closed-cell foam materials. According to an embodiment of the invention, the one or more foam materials comprise polyethylene and/or ethylene vinyl acetate copolymer. According to an embodiment of the invention, any one of or all of the upper material layer 12, the intermediate material layer 13, the lower foam material layer 11, and the connecting element 14, 21, are formed with a foam material other than polyethylene or ethylene vinyl acetate copolymer.

According to an embodiment of the invention, the resilient element 10, 20 are resilient columnar elements, and the shape of the transection of the resilient element can be any shape, such as, triangle, square, rectangle, hexagon, circle, oval, and polygon. According to an embodiment of the invention, a shape of the resilient element 10, 20 is of one of the following shapes: hexagonal column, cylinder, triangular prism, quadrangle prism, spheroid, ellipsoid, and cone.

According to an embodiment of the invention, a portion of or all of the resilient elements 10, 20 of the foam structure are provided with a concave portion 15, 22 on a top surface thereof. According to an embodiment of the invention, the concave portion 15 on the top surface of the resilient elements 10 is formed by providing at least a through hole 121 on the upper material layer 12. According to an embodiment of the invention, the concave portion 15 on the top surface of the resilient elements 10 is formed by providing a through hole 121, 131 on each of the upper material layer 12 and the intermediate material layer 13. According to an embodiment of the invention, the concave portion 15 on the top surface of the resilient elements is formed by providing a through hole 121 on the upper material layer and a through hole 131 of the intermediate material layer and a dimple 111 on the lower foam layer 11. According to an embodiment of the invention, all or partial of resilient elements 20 of the integral formed foam structure are provided with the concave portion 22 on its top surface.

According to an embodiment of the invention, the top surface of the resilient elements 10, 20 is provided with formation 15, 22 to increase a contact friction. According to an embodiment of the invention, the concave portion 15, 22 on the top surface of the resilient elements 10, 20 is provided to increase a contact friction. According to an embodiment of the invention, the top surface of the resilient elements 10, 20 is provided with formation 15, 22 to decrease an air resistance. According to an embodiment of the invention, the concave portion 15, 22 on the top surface of the resilient elements is provided to increase an air resistance.

According to an embodiment of the invention, the foam structure 10, 20 is provided with a top fabric (not shown) over a top surface of the plurality of resilient elements and/or a bottom fabric (not shown) over a bottom surface of the plurality of resilient elements 10, 20 to form a protective pad (not shown). According to an embodiment of the invention, both or either the top fabric and the bottom fabric is an air permeable fabric. According to an embodiment of the invention, the air permeable fabric can be provided by bonded the air permeable fabric over the surface of resilient elements.

The present invention has been described with preferred embodiments thereof, and it is understood that many variations and modifications to the described embodiment can be carried out without departing from the scope and the spirit of the invention that is intended to be limited only by the appended claims.

What is claimed is:

1. A foam structure, comprising:
a plurality of resilient elements for deforming to absorb energy when an external force is applied thereon; and
a plurality of flexible connecting elements, each for connecting between at least two of the resilient elements;
wherein at least a portion of the resilient elements are provided with a concave portion on a top surface thereof, and
wherein among a plurality of adjacent pairs of the resilient elements, at least a portion of the plurality of adjacent pairs are each provided with an interspace therebetween.

2. The foam structure as defined in claim 1, wherein the plurality of resilient elements each comprises a first material layer made of resilient foam material, and a second material layer provided above first material layer, and the flexible connecting elements are connected between the second material layers.

3. The foam structure as defined in claim 2, wherein the plurality of resilient elements each comprises further comprises a third material layer above the second material layer.

4. The foam structure as defined in claim 3, wherein the foam structure is provided with a top fabric over a top surface of the first material layer and a bottom fabric over a bottom surface of the first material layer, and wherein the top fabric and the bottom fabric are an air permeable fabric.

5. The foam structure as defined in claim 3, wherein the second material layer and the third material layer are formed with a foam material.

6. The foam structure as defined in claim 2, wherein the flexible connecting element is a sheet of flexible connecting segment.

7. The foam structure as defined in claim 2, wherein the concave portion on the top surface of the resilient elements is formed by at least a through hole of the second material layer.

8. The foam structure as defined in claim 3, wherein the concave portion on the top surface of the resilient elements is formed by a through hole of the second material layer and a dimple on the first material layer.

9. The foam structure as defined in claim 3, wherein the concave portion on the top surface of the resilient elements is formed by a through hole on the third material layer, a through hole of the second material layer, and a dimple on the first material layer.

10. The foam structure as defined in claim 1, wherein the resilient element are resilient columnar elements.

11. The foam structure as defined in claim 1, wherein the resilient element are resilient columnar elements, and a shape of a transection of the resilient columnar element is of one of the following shapes: triangle, square, rectangle, hexagon, circle, oval, and polygon.

12. The foam structure as defined in claim 1, wherein the top surface of the resilient elements is provided with formation to increase a contact friction.

13. The foam structure as defined in claim 1, wherein the top surface of the resilient elements is provided with formation to decrease an air resistance.

14. The foam structure as defined in claim 1, wherein the plurality of resilient elements and the plurality of flexible connecting elements are integrally formed by integral molding of foam material.

15. The foam structure as defined in claim 14, wherein the foam structure is provided with a top fabric over a top surface of the plurality of resilient elements and a bottom fabric over a bottom surface of the plurality of resilient elements.

16. The foam structure as defined in claim 15, wherein at least one of the top fabric and the bottom fabric is an air permeable fabric.

17. The foam structure as defined in claim 14, wherein the material of foam structure comprises polyethylene and/or ethylene vinyl acetate.

18. The foam structure as defined in claim 14, wherein a shape of the resilient element is of one of the following shapes: hexagonal column, cylinder, triangular prism, quadrangle prism, spheroid, ellipsoid, and cone.

19. The foam structure as defined in claim 14, wherein the top surface of the resilient elements is provided with formation to increase a contact friction.

20. The foam structure as defined in claim 14, wherein the top surface of the resilient elements is provided with formation to decrease an air resistance.
